(19) United States
(12) Patent Application Publication
(10) Pub. No.: US 2016/0036939 A1
(43) Pub. Date: Feb. 4, 2016

(54) Selecting Content for Simultaneous Viewing by Multiple Users

(71) Applicant: Google Inc., Mountain View, CA (US)

(72) Inventors: Martin B. Freund, Mountain View, CA (US); Sarah Xie, Mountain View, CA (US)

(21) Appl. No.: 14/040,238

(22) Filed: Sep. 27, 2013

(51) Int. Cl. H04L 29/08

(52) U.S. Cl. CPC H04L 67/306

(57) ABSTRACT

Methods, systems, and apparatus include computer programs encoded on a computer-readable storage medium for providing content to a group of users. A method includes: determining that a plurality of users are in proximity to each other and a likelihood that the users are viewing content on a single device; receiving a request for content from the single device; identifying a profile associated with each of the plurality of users, the profile for use in identifying relevant content for delivery to a respective user; creating a group profile based on the identified profiles; and selecting one or more content items for delivery responsive to the request based at least in part on the group profile.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for providing content to a group of users. A method includes: determining that a plurality of users are in proximity to each other and a likelihood that the users are viewing content on a single device; receiving a request for content from the single device; identifying a profile associated with each of the plurality of users, the profile for use in identifying relevant content for delivery to a respective user; creating a group profile based on the identified profiles; and selecting one or more content items for delivery responsive to the request based at least in part on the group profile.

In general, another aspect of the subject matter described in this specification can be implemented in computer program products. A computer program product is tangibly embodied in a computer-readable storage device and comprises instructions. The instructions, when executed by a processor, cause the processor to: determine that a plurality of users are in proximity to each other and a likelihood that the users are viewing content on a single device; receive a request for content from the single device; identify a profile associated with each of the plurality of users, the profile for use in identifying relevant content for delivery to a respective user; create a group profile based on the identified profiles; and select one or more content items for delivery responsive to the request based at least in part on the group profile.

In general, another aspect of the subject matter described in this specification can be implemented in systems. A system includes one or more processing devices and one or more storage devices. The storage devices store instructions that, when executed by the one or more processing devices, cause the one or more processing devices to: determine that a plurality of users are in proximity to each other and a likelihood that the users are viewing content on a single device; receive a request for content from the single device; identify a profile associated with each of the plurality of users, the profile for use in identifying relevant content for delivery to a respective user; create a group profile based on the identified profiles; and select one or more content items for delivery responsive to the request based at least in part on the group profile.

These and other implementations can each optionally include one or more of the following features. Determining that a plurality of users are in proximity can include determining that the plurality of users are logged into a service and are located at a same location based on location information provided by a device associated with a respective user or the service. Determining that a plurality of users is in proximity can include querying one or more of the plurality of users to determine the likelihood. Receiving a request can include receiving a request for an advertisement to be included in a slot on a resource or to be provided along with search results. Creating a group profile can include creating the group profile in real time. Creating the group profile can include creating the group profile prior to determining the plurality of users is in proximity to each other. Creating the group profile can include identifying candidate groups of individuals for group targeting and creating a group profile for a candidate group based on profiles for individuals in the group. The candidate groups can be identified based on known relationships, interactions, or affinities of the respective users. The group profile can be stored and can be updated based on performance information for content that was selected to be presented to the group. The updated group profile can be used to select content to present to one or more members in the group when they are viewing content as a group in the future. An individual profile can include one or more characteristics that are associated with an individual user and creating the group profile can include weighting an importance of the one or more characteristics in the group profile based on an influence score associated with the individual user. A user interface can be provided to a content sponsor to facilitate selection of selection parameters to be associated with delivery of their content. The user interface can include one or more controls for enabling the content sponsor to designate selection criteria wherein at least one selection criterion can be for a display environment for the content sponsor's content to be a multi-party display environment. The user interface can include controls for enabling the content sponsor to specify one or more other characteristics of the parties in the multi-party environment that would be eligible for receipt of the content from the content sponsor. Information can be received from the service or the single device to develop situational awareness of a reason or occasion that the group has come together and selecting one or more content items can include selecting a content item based at least in part on the situational awareness.

Particular implementations may realize none, one or more of the following advantages. Content that is presented to multiple users viewing a single device can be selected based on a group profile determined for the multiple users. A content sponsor can specify that a content item is eligible to be selected for presentation to a particular type of group of users viewing a single device.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a group of users.

FIGS. 2A and 2B are block diagrams of example systems for providing content to a group of users.

FIG. 3 illustrates an example campaign management user interface.

FIGS. 4 and 5 are flowcharts of example processes for providing content to a group of users.

FIG. 6 is a block diagram of computing devices that may be used to implement the systems and methods described in this document, as either a client or as a server or plurality of servers.

Like reference numbers and designations in the various drawings indicate like elements.

### DETAILED DESCRIPTION

Systems and methods are providing for selecting content to be presented to a group of users, such as a group that are viewing a same device. For example, a determination can be made that a plurality of users are in proximity to each other, such as based on location information associated with some or all of the users and/or based on some or all of the users being connected to a same local network. A likelihood that the users are viewing content on a single device can be determined. The single device can be, for example, a television, a computer screen, a tablet or other device. A request for content can be received from the single device, such as for content to be included in a slot on a resource or to be provided along with search results responsive to a received query. A profile associated with each of the plurality of users can be identified for use in identifying relevant content for delivery to a respective user. A group profile can be created based on the identified profiles and one or more content items can be selected for delivery responsive to the request based at least in part on the group profile.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be manipulated in one or more ways before it is stored or used, so that certain information about the user is removed. For example, a user's identity may be manipulated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

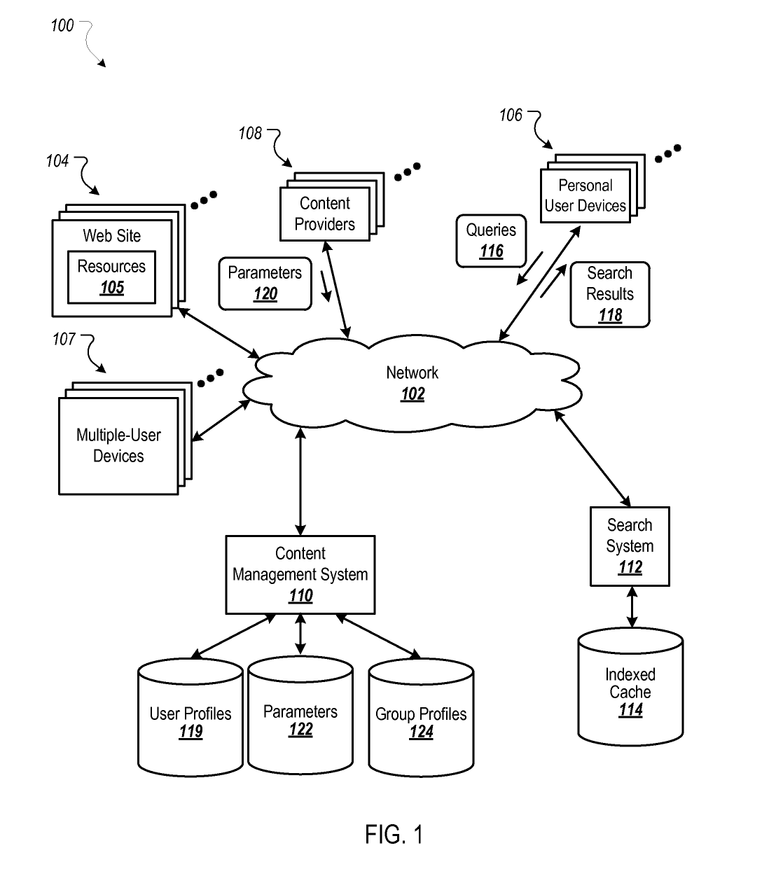

FIG. 1 is a block diagram of an example environment 100 for providing content to a group of users. The example environment 100 includes a network 102, such as a local area network (LAN), a wide area network (WAN), the Internet, or a combination thereof. The network 102 connects websites 104, personal user devices 106, multiple-user devices 107, content providers 108, publishers, and a content management system 110. The example environment 100 may include many thousands of websites 104, personal user devices 106, multiple-user devices 107, and content providers 108. The content management system 110 may be used for selecting and providing content in response to requests for content. The content providers 108 can be, for example, advertisers. Other types of content providers are possible.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as scripts).

A personal user device 106 is an electronic device that is under control of a user and is capable of requesting and receiving resources 105 over the network 102. Example personal user devices 106 include personal computers, tablet computers, mobile communication devices (e.g., smartphones), televisions, set top boxes, personal digital assistants and other devices that can send and receive data over the network 102. A personal user device 106 typically includes one or more user applications, such as a web browser, to facilitate the sending and receiving of data over the network 102. The web browser can interact with various types of web applications, such as a game, a map application, or an e-mail application, to name a few examples.

A personal user device 106 can request resources 105 from a website 104. In turn, data representing the resource 105 can be provided to the personal user device 106 for presentation by the personal user device 106. Personal user devices 106 can also submit search queries 116 to the search system 112 over the network 102. In response to a search query 116, the search system 112 can, for example, access the indexed cache 114 to identify resources 105 that are relevant to the search query 116. The search system 112 identifies the resources 105 in the form of search results 118 and returns the search results 118 to the personal user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a personal user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. The request for content can include a user identifier (e.g., a cookie) associated with the user of the requesting personal user device 106.

Based, for example, on data included in the request for content, the content management system 110 can select content items that are eligible to be provided in response to the request, such as content items having characteristics matching the characteristics of a given slot. As another example, content items having selection criteria (e.g., keywords) that match the resource keywords or the search query 116 may be selected as eligible content items by the content management system 110. As yet another example, content items matching information stored in a user profile associated with a user of the personal user device 106 can be selected as eligible content items. User profiles can be stored, for example, in a user profiles data store 119. One or more selected content items can be provided to the personal user device 106 in association with providing an associated resource 105 or search results 118.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define a content campaign. The content campaign can be created and activated for the content provider 108 according to the parameters 120 specified by the content provider 108. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and/or one or more selection terms. As another example, selection criteria can include criteria that makes a content item eligible for presentation to a group of users when a likelihood is determined that users in the group are viewing content on a multi-user device 107.

The multiple-user devices 107 are devices on which content is presented and viewed simultaneously by multiple users. The multiple-user devices 107 can include, for example, televisions, computing devices, gaming systems, and movie theatre systems. The content management system 110 can determine a likelihood that multiple users are viewing a particular multiple-user device 107. For example, the content management system 110 can determine that the multiple users are in proximity to each other and to the multiple-user device 107, such as based on location information associated with personal user devices 106 of the multiple users and with the multiple-user device 107 and/or on the personal user devices 106 of the multiple users each being connected to a same network.

The content management system 110 can receive a request for content from a multiple-user device 107, such as for an advertisement or other content to be included in a slot on a resource 105 (or along with search results) presented on the multiple-user device 107. The content management system 110 can identify a profile associated with some or all of the multiple users, such as from the user profiles data store 119. As described in more detail below, the content management system 110 can create a group profile based on the identified profiles. The group profile can be stored in a group profiles data store 124 and can include information such as common interests and other summary information describing the group, such as average age, gender distribution, etc. The content management system 110 can select one or more content items for delivery to the multiple-user device 107 in response to the request for content received from the multiple-user device 107, based at least in part on the group profile.

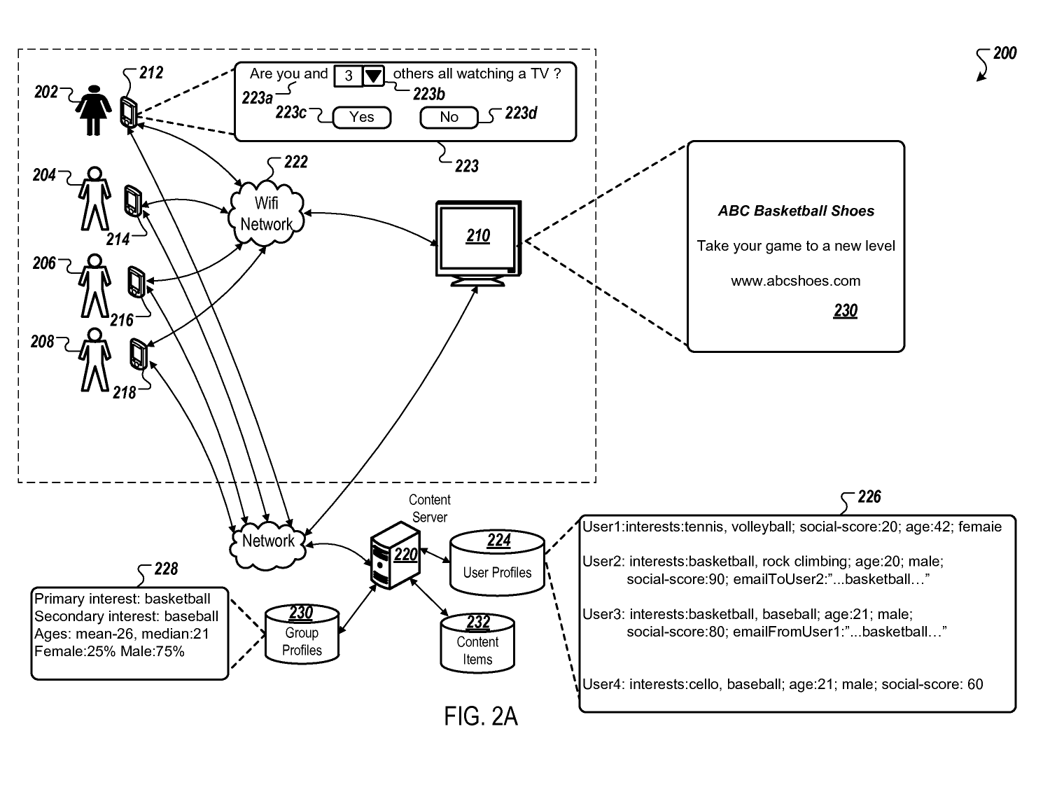

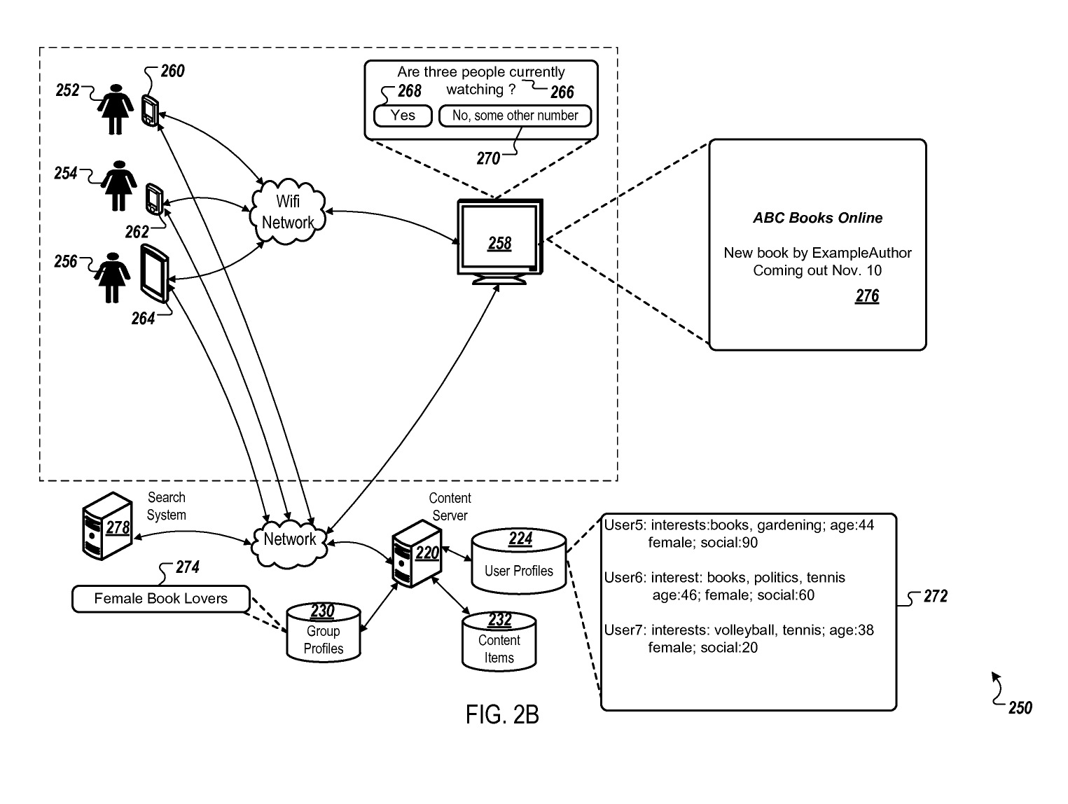

FIG. 2A is a block diagram of an example system 200 for providing content to a group of users. Users 202 (user1), 204 (user2), 206 (user3), and 208 (user4) are located in a same room, watching a television 210. The users 202, 204, 206, and 208 are using mobile devices 212, 214, 216, and 218, respectively. Some or all of the user devices 212, 214, 216, and 218 may be logged into a service associated with a content server 220.

The content server 220 can determine that the users 202, 204, 206, and 208 are in proximity to each other. For example, the content server 220 can determine that the mobile devices 212, 214, 216, and 218 are each connected to a same local network 222. The local network 222 can be, for example, a WiFi (Wireless Fidelity) network, a Bluetooth™ network, or some other type of network. As another example, the content server 220 can determine that the users 202, 204, 206, and 208 are in proximity to each other based on location information respectively provided by the mobile devices 212, 214, 216, and 218 indicating that the users 202, 204, 206, and 208 are at a same location. Based on the connection to the local network 222 and/or based on the location information associated with the mobile devices 212, 214, 216, and 218, the content server 220 can determine a likelihood that the users 202, 204, 206, and 208 are viewing content on the television 210.

As another example, the content server 220 can query one or more of the users 202, 204, 206, and 208 regarding whether one or more of the users 202, 204, 206, and 208 are viewing content on the television 210. For example, a user interface 223 can be provided to and presented on the mobile device 212 of the user 202. The user interface 223 includes a query 223a asking the user 202 if the user 202 and a particular number of other people (e.g., three) are watching content on the television 210. The user 202 can use a control 223b to change the particular number to some other number. The user 202 can select a control 223c to confirm that the user 202 and the number of other users indicated by the control 223b are watching the television 210. The user 202 can select a control 223d to provide an answer of “No” to the query 223a. An indication of the selection of the control 223c or the control 223d and an indication of the number displayed in the control 223b can be sent to the content server 220. In some implementations, the query can include the names of the other potential viewers and the feedback from the user 202 can include feedback to designate particular ones of the potential viewers as actually viewing the multi-user device 207.

As part of the presenting of content on the television 210, the television 210 can provide a request for content to the content server 220, such as for an advertisement or other content item to be included in a slot on a resource presented on the television 210. In response to the request for content, the content server 220 can identify a profile associated with each of the users 202, 204, 206, and 208, such as from a user profiles data store 224. For example, as illustrated by example profile data 226, a profile for the user 202 indicates that the user 202 has interests of tennis and volleyball, is female, is 42 years old, and has a social influencer score of 20. Social influencer scores are discussed in more detail below. The example profile data 226 indicates that the user 204 is a male 20 year old who likes basketball and rock climbing, has a social influencer score of 90, and recently emailed the user 206 about basketball. The example profile data 226 indicates that the user 206 is a male 21 year old who likes basketball and baseball, has a social influencer score of 80, and received an email from the user 204 about basketball. The example profile data 226 indicates that the user 208 is a male 21 year old who likes cello and baseball and has a social influencer score of 60.

The content server 220 can create a group profile 228 based on the example profile data 226. The group profile 228 can include, for example, information common to the user profiles associated with the users 202, 204, 206, and 208 or information that summarizes information included in the user profiles associated with the users 202, 204, 206, and 208. For example, the group profile 228 includes a primary interest of basketball, a secondary interest of baseball, age information indicating a mean age of 26 and a median age of 21, and a gender distribution indicating 75% male and 25% female. The group profile 228 can be stored in a group profiles data store 230.

The content server 220 can determine information to include in the group profile 228 and/or can weight an importance of one or more items in the group profile 228 based on the example profile data 226. For example, the content server 220 can weight an item included in the group profile 228 based on one or more factors. In some implementations, the weight can be based on an influence score associated with a particular user. For example, a characteristic that is included in a user profile of a user who has a higher social influence score can be weighted higher with regards to consideration of inclusion in the group profile 228 than a characteristic that is included in a user profile of a user who has a lower social influence score.

For example, although both baseball and basketball interests are included twice in the example profile data 226, basketball may be weighted higher than baseball. For example, a basketball interest is included in the user profiles of the user 204 and the user 206, with the user 204 and the user 206 having social influence scores of 90 and 80, respectively, while a baseball interest is included in the user profiles of the user 206 and the user 208, with the user 206 and the user 208 having social influence scores of 80 and 60, respectively. The content server 220 can include basketball as a primary interest and baseball as a secondary interest in the group profile 228 based on the basketball interest being associated with users having higher social influence scores than the social influence scores of users having an interest in baseball.

A social influence score for a user can be determined, for example, based on a number of factors. For example, a user with a higher social influence score may have more connections in a social network than a user with a lower social influence score. Social influence scores can be based on other factors, such as a volume of social network posts, a number or a percentage of posts that are replied to, interacted with, or shared by other users, an average response time to others' social posts, a frequency of response to others' social posts, etc.

Other criteria can be used to determine the contents of the group profile 228. For example, in some implementations, a characteristic, such as an interest, can be included in the group profile 228 if more than a threshold number or more than a threshold percentage of user profiles include the characteristic. For example, basketball and baseball can be included in the group profile 228 when the threshold is one.

The content server 220 can select one or more content items for delivery to the television 210 in response to the request for content based at least in part on the group profile 228. For example, the content server 220 can select a content item 230 related to basketball (e.g., basketball shoes) from a content items data store 232 based on the primary interest of basketball included in the group profile 228. The content item 230 can be provided to and presented on the television 210.

As another example, FIG. 2B is a block diagram of an example system 250 for providing content to a group of users. Users 252 (user5), 254 (user6), and 256 (user7) are watching a television 258. The users 252, 254, and 256 are using user devices 260, 262, and 264, respectively. Some or all of the user devices 260, 262, and 264 may be logged into a service associated with the content server 220. The content server 220 can determine that the users 252, 254, and 256 are in proximity to each other and that the users 252, 254, and 256 are likely watching content on the television 258, such as based on location information or local network connectivity information associated with the user devices 260, 262, and 264, respectively. As another example, a query 266 can be presented on the television 258 and one of the users 252, 254, or 256 can answer the query 266, such as by using a remote control associated with the television 258. For example, a control 268 can be selected to confirm that three users are currently watching the television 258 or a control 270 can be selected to answer “no” to the query 266. In response to a “no” answer, a user interface may be presented on the television 258 which allows entry of a number which represents the number of people currently watching the television 258.

The television 258 can provide a request for content to the content server 220, such as for an advertisement or other content item to be included in a slot on a resource presented on the television 258. In response to the request for content, the content server 220 can identify a profile associated with each of the users 252, 254, and 256, such as from the user profiles data store 224. For example, as illustrated by example profile data 272, a profile for the user 252 indicates that the user 252 has interests of books and gardening, is female, is 44 years old, and has a social influencer score of 90. The example profile data 272 indicates that the user 254 is a female 46 year old who likes books, politics, and tennis and has a social influencer score of 60. The example profile data 272 indicates that the user 256 is a female 38 year old who likes volleyball and tennis and has a social influencer score of 20.

The content server 220 can identify, in the group profile data store 230, a predefined group profile 274 associated, for example, with “female book lovers”. For example, the content server 220 can determine that a similarity score between the group profile 274 and the example profile data 272 is greater than a threshold. The characteristic of “books” can carry more weight in identification or creation of a group profile than, for example, a characteristic of tennis, based on the characteristic of books being associated with users who have higher social influencer scores than users who are associated with the characteristic of tennis.

The content server 220 can select one or more content items for delivery to the television 258 in response to the request for content based at least in part on the group profile 274. For example, the content server 220 can select a content item 276 related to books from the content items data store 232 based on the predefined group profile 274. The content item 276 can be provided to and presented on the television 258.

The content server 220 can select a content item based on other factors, such as based on recent searches submitted by one or more of the users 252, 254, and 256 to a search system 278 (e.g., such a determination may be made by querying the user profiles data store 224, querying an activity log, or by receiving information from the search system 278, such as information from search logs). In some implementations, the content server 220 can determine user activity of one or more of the users 252, 254, and 256 that can be identified as a “current activity”, e.g., activity likely to have occurred within a threshold time (e.g., thirty minutes) of the request for content received from the television 258 and at the same location as the television 258. The content server 220 can, for example, select a content item based at least in part on the identified current activity. As another example, the content server 220 can identify or create a group profile based at least in part on the identified current activity and on the example profile data 272. For example, the current activity may include information that is not included in the example profile data 272.

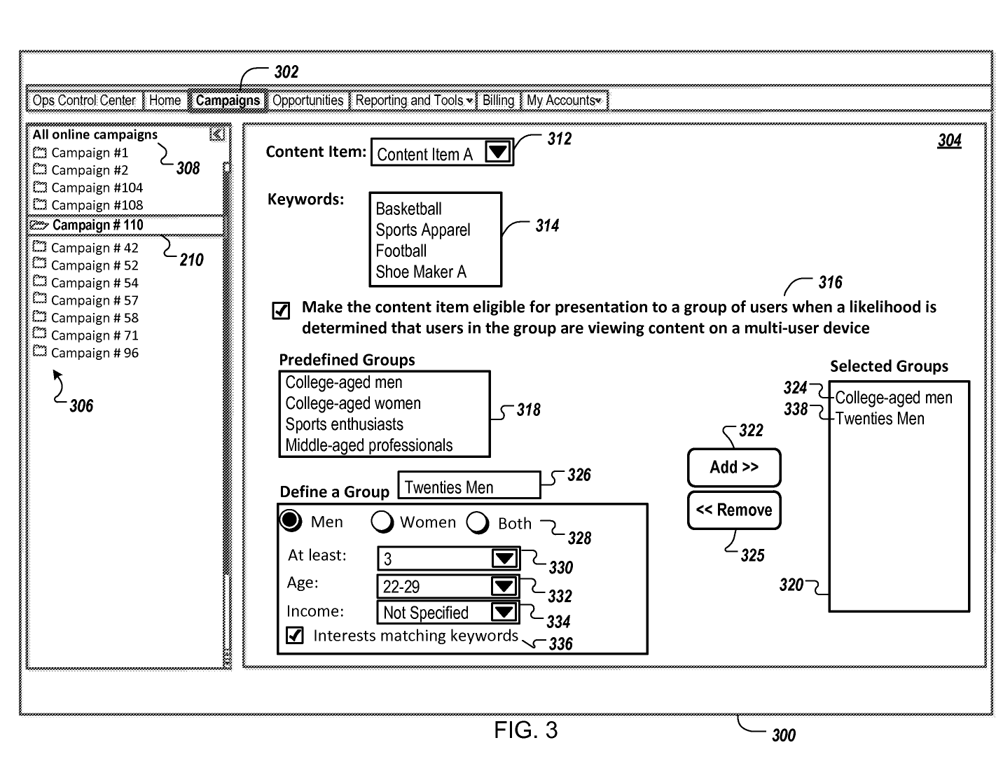

FIG. 3 illustrates an example campaign management user interface 300. The user interface 300 can be included, for example, in one or more user interfaces that a user, such as a content item provider or content sponsor, can use to configure a campaign. The content item provider can select a tab 302 to display a campaign configuration area 304. The content item provider can view a list 306 of campaigns by selecting a control 308. The content item provider can edit an existing campaign in the campaign configuration area 304 by selecting the name of an existing campaign (e.g., a name 310) in the campaign list 306. The content item provider can select a content item associated with the campaign using a control 312.

The content item provider can select one or more keywords to be associated with the content item using a control 314. The selected keywords can be used as selection criteria for the selected content item. A control 316 can be selected to make the selected content item eligible for presentation to a group of users when a likelihood is determined that users in the group are viewing content on a multi-user device.

The content item provider can select one or more predefined groups using a control 318 and can add the selected group(s) to a selected groups list 320 using an add control 322. For example, the selected groups list 320 includes a predefined “college-aged men” group 324. A group can be removed from the selected groups list 322 using a remove control 325.

The content item provider can define a custom group. A name for the custom group can be entered using a control 326 (e.g., “twenties men”). The content item provider can configure characteristics of members of the custom group or characteristics of the custom group in general. For example, one of gender controls 328 can be selected to specify whether the custom group is to include men, women, or both men and women. For example, the gender controls 328 include a selected control corresponding to men. As other examples, controls 330, 332, and 334 can be used to specify a minimum number of people to be included in the group (e.g., three), an age range (e.g., twenty two to twenty nine) of members in the group, and an income range of members in the group, respectively. A control 336 can be selected to indicate the members of the group are to have interests (e.g., in a user profile) that match one or more of the keywords included in the control 314.

The custom group can be added to the selected groups list 320 using the add control 322. For example, the selected groups list includes a twenties-men group 338. In response to selection of the control 316 and inclusion of the college-aged men group 324 and the twenties-men group 338 in the selected groups list 320, a content server can provide the selected content item in response to a request for content from a multi-user device based at least in part on a determination being made that users in a group of users matching either the college-aged men group 324 or the twenties-men group 338 are viewing content on the multi-user device.

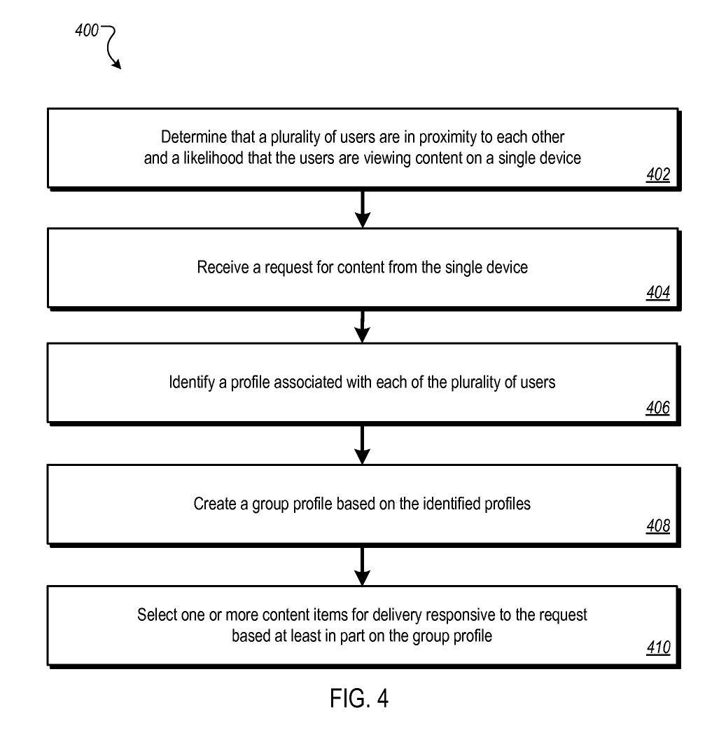

FIG. 4 is a flowchart of an example process 400 for providing content to a group of users. The process 400 can be performed, for example, by the content management system 110 described above with respect to FIG. 1, or the content server 220 described above with respect to FIG. 2A.

A determination is made that a plurality of users are in proximity to each other and a likelihood that the users are viewing content on a single device is determined (402). For example, a determination can be made that the plurality of users are logged into a service and are located at a same location based on location information provided by a device associated with a respective user or the service. The likelihood that the users are viewing content on the single device can be based on the location information of the users matching location information associated with the single device and based on the location information of the users indicating that the users have stayed at a same location for a particular period of time (e.g., thirty minutes, one hour).

As another example, a determination can be made that the plurality of users are connected to a same network (e.g., a local network, such as a WiFi network). In some implementations, one or more of the plurality of users are queried to determine the likelihood. For example, a query can be sent to one or more of the plurality of users asking the one or more users if the plurality of users are viewing the single device. In some implementations, other techniques can be used to determine the likelihood that the users are viewing content on the single device. For example, a camera included in or associated with the single device can detect the presence of each of the plurality of users. The single device can be, for example, a television, a gaming system, a movie theatre system, or some other type of device.

A request for content is received from the single device (404). For example, when the single device is a television, the request for content can be for an advertisement to be included in a slot on a resource presented on the television. When the single device is a gaming system, the request for content can be for a content item (e.g., advertisement) to display in a content slot presented on a display of the gaming system or can be for content to display during game play. For example, content item providers can bid on content to display in a portion of the game play of a game played in the gaming system. When the single device is a movie theatre system, the request for content can be, for example, for content to display in a pre-movie content segment. As another example, the request for content can be for content to display in a movie. For example, content item providers can bid for an opportunity to display a scene of a particular product (e.g., car, billboard advertisement, consumption of a product) in a movie, with the presentation of the movie including a scene including a product of the winning content provider.

A profile associated with each of the plurality of users is identified (406). A respective profile can be for use in identifying relevant content for delivery to a respective user. A respective profile can include information, for example, about the associated user's interest, age, income, gender, or other characteristics, when the user has consented for use and storage of such information.

A group profile is created based on the identified profiles (408). In some implementations, the group profile is created in real time, such as in response to the determination that the plurality of users are in proximity to each other or in response to the request for content from the single device. In some implementations, the group profile is created prior to determining that the plurality of users is in proximity to each other. For example, candidate groups of individuals for group targeting can be identified, such as based on known relationships, interactions or affinities of the respective users. For example, a group of college friends who interact with each other frequently through social networking sites can be identified as a candidate group. As another example, a husband, wife, and children can be identified as a candidate group based on known relationships between the family individuals. A group profile for a candidate group can be created based on the profiles for individuals in the group.

In some implementations, the created group profile is based on a predefined group profile. For example, a predefined group profile may exist for a family having certain characteristics, such as parents and children each in particular age ranges and a particular number of children. As another example, a predefined group profile may exist for “college friends”. A determination can be made that the plurality of users matches the existing college-friends group profile based, for example, on the user devices of the plurality of users being connected to a network address that is associated with a college dormitory.

In general, the group profile can include characteristics that are common to some or all of the individual profiles. For example, the group profile can include common interests. As another example, the group profile can include summary information that summarizes information in the individual profiles, such as a gender, age, income, or other distributions, a median or mean age or income, etc. An importance of one or more characteristics in the group profile can be weighted based on influence scores associated with individual users. For example characteristics that are associated with users having more influence can be weighted higher than characteristics that are associated with users having less influence.

One or more content items are selected for delivery responsive to the request based at least in part on the group profile (410). When the single device is a television, a content item can be selected to be presented on the television. When the single device is a gaming system, a content item to be presented during game play can be selected. When the single device is a movie theatre system, a content item to display during movie previews or within a movie can be selected. In some implementations, information from a service or the single device can be used to develop situational awareness of a reason or an occasion that the group has come together and one or more content items can be selected based on the situational awareness. For example, a determination can be made of a significant event (e.g., birthday, anniversary) related to one or more of the individual users. As another example, selecting of a content item can be based on determining a match between an interest (e.g., football) associated with more than a threshold of the users and a particular type of content (e.g., a football game) being presented on the single device.

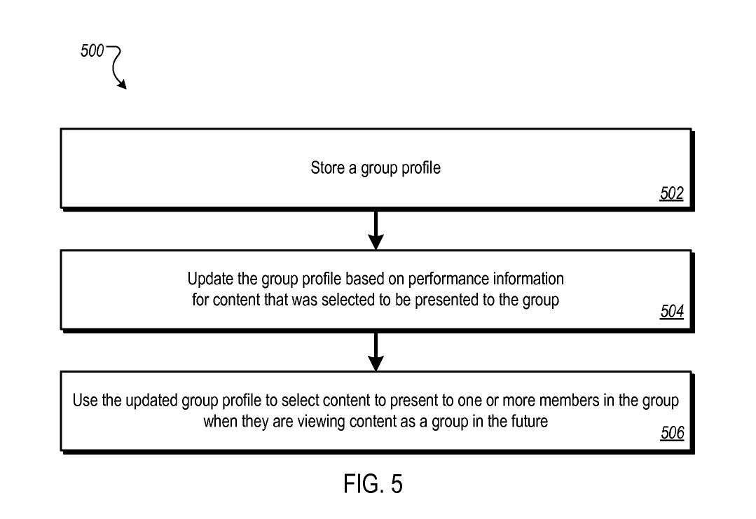

FIG. 5 is a flowchart of an example process 500 for providing content to a group of users. The process 500 can be performed, for example, by the content management system 110 described above with respect to FIG. 1, or the content server 220 described above with respect to FIG. 2A.

A group profile is stored (502). For example, the group profile can be stored in a group profiles data store such as the group profiles data store 124 described above with respect to FIG. 1. The group profile can be created and stored, for example, for a group of users in response to a request for content from a multi-user device that is displaying content being viewed by the group of users.

The group profile is updated based on performance information for content that was selected to be presented to the group (504). For example, performance information, such as conversion information, can be tracked for the users included in the group and can be stored in the group profile. A conversion can occur, for example, using the multi-user device or using some other device such as a personal user device associated with one of the users in the group. The multi-user device may include, for example, a touch display or other user input device with which users can provide input and perform conversion actions for a content item presented on the multi-user device. The multi-user device may be interactive in other ways, such as being an interactive television which with users in the group can interact, such as using a remote control. A user can, for example, perform a conversion action, such as making a purchase, using the remote control. As another example, one or more of the users may perform a conversion action using a personal user device subsequent to presentation of content on the multi-user device, with the conversion action attributable at least in part due to the presentation of content on the multi-user device.

The updated group profile is used to select content to present to one or more members in the group when they are viewing content as a group in the future (506). For example, in response to a request for content, a content item with a highest conversion rate among content items previously presented to the group can be identified and a content item similar to the identified content item can be selected in response to the request.

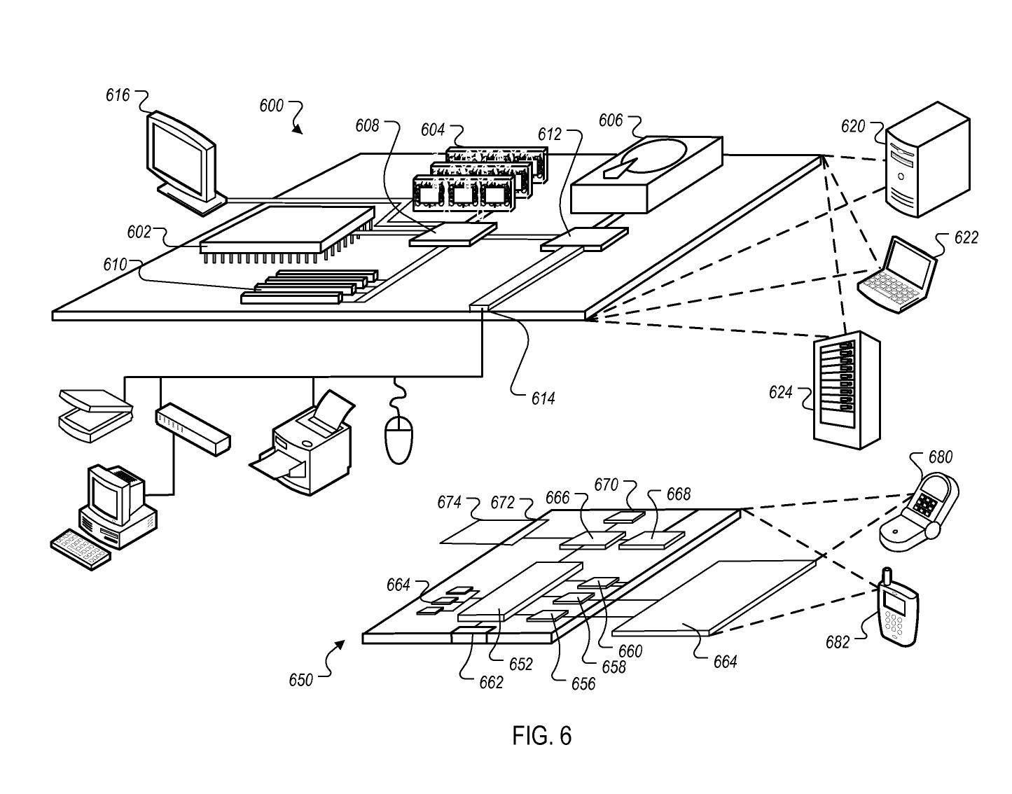

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. The computer-readable medium is not a propagating signal. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is illustrative only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communication audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
determining that a plurality of users are in proximity to each other and a likelihood that the users are viewing content on a single device;
receiving a request for content from the single device;
identifying a profile associated with each of the plurality of users, the profile for use in identifying relevant content for delivery to a respective user;
creating a group profile based on the identified profiles; and
selecting one or more content items for delivery responsive to the request based at least in part on the group profile.

2. The method of claim 1 wherein determining that a plurality of users are in proximity includes determining that the plurality of users are logged into a service and are located at a same location based on location information provided by a device associated with a respective user or the service.

3. The method of claim 2 wherein determining includes querying one or more of the plurality of users to determine the likelihood.

4. The method of claim 1 wherein receiving a request includes receiving a request for an advertisement to be included in a slot on a resource or to be provided along with search results.

5. The method of claim 1 wherein creating a group profile includes creating the group profile in real time.

6. The method of claim 1 wherein creating the group profile includes creating the group profile prior to determining the plurality of users are in proximity to each other.

7. The method of claim 6 wherein creating the group profile includes identifying candidate groups of individuals for group targeting and creating a group profile for a candidate group based on profiles for individuals in the group.

8. The method of claim 7 wherein the candidate groups are identified based on known relationships, interactions, or affinities of the respective users.

9. The method of claim 1 further comprising storing the group profile, updating the group profile based on performance information for content that was selected to be presented to the group, and using the updated group profile to select content to present to one or more members in the group when they are viewing content as a group in the future.

10. The method of claim 1 wherein an individual profile includes one or more characteristics that are associated with an individual user and wherein creating the group profile includes weighting an importance of the one or more characteristics in the group profile based on an influence score associated with the individual user.

11. The method of claim 1 further comprising providing a user interface to a content sponsor to facilitate selection of selection parameters to be associated with delivery of their content and wherein the user interface includes one or more controls for enabling the content sponsor to designate selection criteria wherein at least one selection criterion is for a display environment for the content sponsor's content to be a multi-party display environment.

12. The method of claim 11 wherein the user interface further includes controls for enabling the content sponsor to specify one or more other characteristics of the parties in the multi-party environment that would be eligible for receipt of the content from the content sponsor.

13. The method of claim 1 further comprising receiving information from the service or the single device to develop situational awareness of a reason or occasion that the group has come together and wherein selecting one or more content items includes selecting a content item based at least in part on the situational awareness.

14. A computing system comprising:
one or more processing devices; and
one or more storage devices storing instructions that, when executed by the one or more processing devices, cause the one or more processing devices to:
determine that a plurality of users are in proximity to each other and a likelihood that the users are viewing content on a single device;
receive a request for content from the single device;
identify a profile associated with each of the plurality of users, the profile for use in identifying relevant content for delivery to a respective user;
create a group profile based on the identified profiles; and
select one or more content items for delivery responsive to the request based at least in part on the group profile.

15. The system of claim 14 wherein determining that a plurality of users are in proximity includes determining that the plurality of users are logged into a service and are located at a same location based on location information provided by a device associated with a respective user or the service.

16. The system of claim 15 wherein determining includes querying one or more of the plurality of users to determine the likelihood.

17. The system of claim 14 wherein the instructions include instructions that, when executed by the one or more processing devices, cause the one or more processing devices to provide a user interface to a content sponsor to facilitate selection of selection parameters to be associated with delivery of their content, wherein the user interface includes one or more controls for enabling the content sponsor to designate selection criteria, wherein at least one selection criterion is for a display environment for the content sponsor's content to be a multi-party display environment.

18. A computer program product tangibly embodied in a computer-readable storage device and comprising instructions that, when executed by a processor, cause the processor to:
determine that a plurality of users are in proximity to each other and a likelihood that the users are viewing content on a single device;
receive a request for content from the single device;
identify a profile associated with each of the plurality of users, the profile for use in identifying relevant content for delivery to a respective user;
create a group profile based on the identified profiles; and
select one or more content items for delivery responsive to the request based at least in part on the group profile.

19. The product of claim 18 wherein determining that a plurality of users are in proximity includes determining that the plurality of users are logged into a service and are located at a same location based on location information provided by a device associated with a respective user or the service.

20. The system of claim 18 wherein determining includes querying one or more of the plurality of users to determine the likelihood.
